(19) United States
(12) Patent Application Publication
(10) Pub. No.: US 2026/0196065 A1
(43) Pub. Date: Jul. 9, 2026

(54) TRACEABILITY SYSTEM

(71) Applicant: Satake Corporation, Chiyoda-ku, Tokyo (JP)

(72) Inventors: Takeshi NISHIMURA, Chiyoda-ku, Tokyo (JP); Tomoyuki MIYAMOTO, Chiyoda-ku, Tokyo (JP)

(21) Appl. No.: 19/131,926

(22) PCT Filed: Dec. 28, 2023
(86) PCT No.: PCT/JP2023/047235

§ 371 Date: May 21, 2025

(30) Foreign Application Priority Data
Jan. 6, 2023 (JP) 2023-001094

(51) Int. Cl. G06V 20/68; G06T 7/00; G06V 10/764; G06V 10/774; G06V 10/82; G06V 20/50

(52) U.S. Cl. CPC G06V 20/68; G06T 7/0004; G06V 10/764; G06V 10/774; G06V 10/82; G06V 20/50; G06T 2207/20081; G06T 2207/20084; G06T 2207/30128; G06V 2201/06

(57) ABSTRACT

A traceability system (1) provided in a distribution process for grain raw materials comprises: an optical sorting machine (7) for inspecting the grain raw materials and separating the same into items meeting a standard and items not meeting the standard; an imaging unit (11) for imaging the items classified as not meeting the standard to obtain a target image; and a first estimating unit (15a) for inputting the target image into an artificial intelligence (18) trained using first classification images and second classification images to estimate a type of the items classified as not meeting the standard.

### TECHNICAL FIELD

The present invention relates to a traceability system provided, for example, in a distribution process for items to be classified such as grain raw materials.

### BACKGROUND ART

As a distribution management system for rice and other grains, a system disclosed in Patent Literature 1 is present. Moreover, as a management system capable of analyzing the types of defective items (damaged grains, immature green grains, unhulled rice, milky white grains or foreign substances) included in grain raw materials, a system disclosed in Patent Literature 2 is present.

### CITATION LIST

### Patent Literature

[Patent Literature 1] Japanese Laid-Open Patent Publication No. 2017-205724

[Patent Literature 2] Japanese Laid-Open Patent Publication No. 2022-15784

### SUMMARY OF INVENTION

### Technical Problem

Although the system disclosed in Patent Literature 1 is intended to enable improvement of the reliability of disclosed information relate to distributed rice and other grains, it cannot always be said that the quality in the distribution process is sufficiently guaranteed. On the other hand, in Patent Literature 2, an optical detector is provided with elements having sensitivity to R (red), G (green) and B (blue), and the values of the R, G and B of a defective item detected by using the elements are compared with a predetermined discriminant to thereby analyze the type of the defective item; however, there is room for improvement in its accuracy.

The present invention is made in view of such circumstances, and an object thereof is to provide a traceability system capable of improving the reliability and safety of the distribution process by estimating the types of the items classified as not meeting the standard such as defective items in order to guarantee the quality in the distribution process.

### Solution to Problem

To achieve the above-mentioned object, the present invention is characterized in that the types of the items classified as not meeting the standard are estimated by using an artificial intelligence.

Specifically, the present invention is directed to a traceability system, and the following solution is implemented:

According to a first aspect of the invention, the following are provided: a separating unit for, when a raw material delivered to a plant is processed into a product and shipped, inspecting the product and separating the product into an item meeting a standard and an item not meeting the standard; an image obtaining unit for imaging the item classified as not meeting the standard to obtain a target image; a first estimating unit for inputting the target image to an artificial intelligence trained using a training image to estimate a type of the item classified as not meeting the standard; a second estimating unit for estimating, by using the artificial intelligence, whether the item classified as not meeting the standard is of pre-delivery origin indicating that mixture occurred before the delivery to the plant or of origin other than that; a third estimating unit for, when the item classified as not meeting the standard is estimated to be of the origin other than that at the second estimating unit, estimating that the item classified as not meeting the standard is of plant origin indicating that mixture occurred in the plant; and a determining unit for, when the item classified as not meeting the standard is estimated to be of the plant origin at the third estimating unit, warning an operator or instructing the operator to provide feedback to a preceding process.

According to a second aspect of the invention, in the first aspect of the invention, the pre-delivery origin is at least one of a raw material origin indicating that mixture occurred in a production place of the raw material and a raw material distribution origin indicating that mixture occurred in a distribution process where the raw material is delivered from the production place to the plant, and the artificial intelligence is trained using first training data where a first training image of the item classified as not meeting the standard and a cause label of the plant origin are associated with each other and second training data where a second training image of the item classified as not meeting the standard and a cause label of the raw material origin are associated with each other.

### Advantageous Effects of Invention

According to the first aspect of the invention, when a target image obtained by imaging an item classified as not meeting the standard is input to the artificial intelligence of the first estimating unit, the type of the item classified as not meeting the standard is estimated at the first estimating unit. Here, since the artificial intelligence is trained using the training images, the type of the item classified as not meeting the standard can be estimated in more detail compared with when the values of R, G and B are compared with a predetermined discriminant as in Patent Literature 1. This enables guarantee of the quality in the distribution process. Moreover, according to the first aspect of the invention, when a raw material is processed into a product at a plant and shipped, the inspection is performed at the separating unit and the product is separated into an item meeting the standard and an item not meeting the standard. Then, the target image obtained by imaging the item not meeting the standard is input to the artificial intelligence of the first estimating unit to enable estimation of the type of the item classified as not meeting the standard at the first estimating unit. By doing this, the type of the item classified as not meeting the standard can be estimated in detail compared with the above-described case of Patent Literature 1, so that the quality in the processing process in the plant can be guaranteed. Moreover, according to the first aspect of the invention, whether the mixture origin of the item classified as not meeting the standard is the pre-delivery to the plant origin or an origin other than that can be estimated by the second estimating unit. By this, whether the item classified as not meeting the standard was mixed before the delivery to the plant or not can be estimated even after the delivery of the raw material to the plant. Moreover, according to the first aspect of the invention, the third estimating unit can estimate that the item classified as not meeting the standard which item is estimated to be of origin other than the pre-delivery origin (the raw material origin or the raw material distribution origin) at the second estimating unit is of plant origin. Moreover, according to the first aspect of the invention, when the item classified as not meeting the standard is estimated to be of plant origin, the operator is warned of this, or the operator is notified of an instruction to provide feedback to the preceding process. Thereby, for example, it is possible to prompt the operator to inspect or stop a machine or the like related to the item classified as not meeting the standard which item is of plant origin.

According to the second aspect of the invention, when the item classified as not meeting the standard is of pre-delivery to the plant origin, the origin can be estimated to be at least one of the raw material origin indicating that mixture occurred in the production place of the raw material and the raw material distribution origin indicating that mixture occurred in the distribution process where the raw material is delivered from the production place to the plant. Moreover, according to the second aspect of the invention, the third estimating unit is capable of estimating the mixture origin of the item classified as not meeting the standard by using the artificial intelligence trained using the first training data and the second training data.

### BRIEF DESCRIPTION OF DRAWINGS

FIG. 1 is a view showing the overall structure of a plant provided with a traceability system according to an embodiment of the present invention.

FIG. 2 is a flowchart showing the control processing of a learning unit.

FIG. 3 is a view showing an example of training data.

FIG. 4 is a view showing an example of the learning processing of an artificial intelligence by the learning unit.

FIG. 5 is a flowchart showing the control processing of an estimating unit.

FIG. 6 is a view showing an example of the estimation processing using a target classification image by the estimating unit.

FIG. 7 is a view showing an example of estimation result output by the estimating unit.

### DESCRIPTION OF EMBODIMENTS

Hereinafter, an embodiment of the present invention will be described in detail based on the drawing. The following description of the preferred embodiment is, in essence, merely for the purpose of illustration.

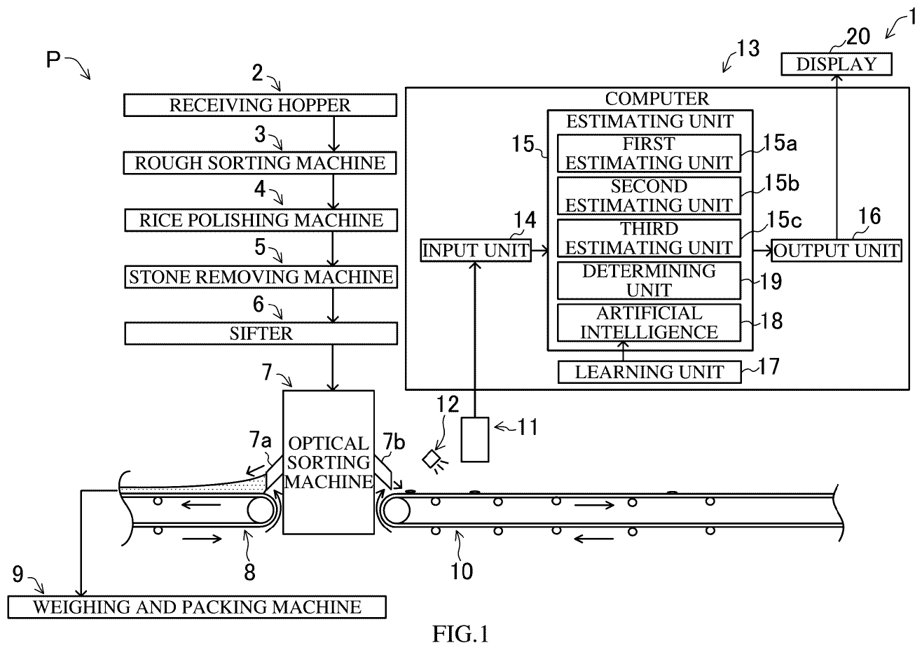

FIG. 1 shows a traceability system 1 according to the embodiment of the present invention. The traceability system 1 is provided in a plant P (for example, a rice milling plant), and at the plant P, brown rice (grain raw material) delivered from farms and the like is polished and bagged, and is then shipped to supermarkets and the like.

The plant P is provided with, for example, a receiving hopper 2, a rough sorting machine 3, a rice polishing machine 4, a stone removing machine 5, a sifter 6, an optical sorting machine (separating unit) 7, a first conveyer 8, a weighing and packing machine 9, and a second conveyer 10.

The brown rice delivered to the plant P from production places such as farms is loaded into the receiving hopper 2. In the present embodiment, a visual receiving inspection using a plastic carton is performed when brown rice is received.

Then, the brown rice loaded into the receiving hopper 2 is fed to the rough sorting machine 3 from the receiving hopper 2.

At the rough sorting machine 3, rough sorting is performed, for example, by a metallic grain sorting screen. Then, the brown rice having undergone the rough sorting by the rough sorting machine 3 is fed to the rice polishing machine 4.

At the rice polishing machine 4, the brown rice is processed into polished rice by having its seed coat and the like removed, for example, by a metallic rice polishing screen.

Then, the polished rice is fed to the stone removing machine 5, and stones mixed in the polished rice are removed at the stone removing machine 5. Thereafter, the polished rice is fed to the sifter 6. Then, the non-defective items or the like fed to the sifter 6 are sifted at the sifter 6. The non-defective items or the like sifted at the sifter 6 are loaded into the optical sorting machine 7, inspected at the optical sorting machine 7, and separated into items meeting a standard and items not meeting the standard, that is, sorted. The items meeting the standard are non-defective items (polished rice) or products meeting the standard (hereinafter, referred to as “non-defective items or the like”). The items not meeting the standard are defective items not meeting the standard, by-products such as bran, and foreign substances such as plastic fragments, rubber fragments, stones and dust unintentionally mixed in the distribution process and in the plant P (hereinafter, referred to as defective items or the like). The “item meeting the standard” in claims corresponds to the “non-defective item or the like” in the present embodiment. The “item not meeting the standard” in claims corresponds to the “defective item or the like” in the present embodiment.

The non-defective items or the like are ejected to the outside of the optical sorting machine 7 through a first ejecting part 7a, and fed to the weighing and packing machine 9 by the first conveyer 8. The non-defective items or the like are bagged at the weighing and packing machine 9, and then, shipped from the plant P to supermarkets and the like.

On the other hand, the defective items or the like inspected at the optical sorting machine 7 are ejected to the outside of the optical sorting machine 7 through a second ejecting part 7b, and then, conveyed, for example, to a non-illustrated defective item collecting unit by the second conveyer 10.

Above the second conveyer 10, an imaging unit 11 and a lighting unit 12 are disposed. The imaging unit 11 which is a camera capable of imaging the defective items or the like images the defective items or the like to thereby obtain target classification images. In the present embodiment, the imaging unit 11 is configured to image all the defective items or the like being conveyed by the second conveyer 10. The “image obtaining unit” in claims corresponds to the “imaging unit” in the present embodiment. The “target image” in claims corresponds to the “target classification image” in the present embodiment.

The lighting unit 12 which is, for example, an LED light is configured to light the imaging range of the imaging unit 11 on the upper surface of the second conveyer 10. In the present embodiment, the defective items or the like are lit by the lighting unit 12 to thereby enable the imaging unit 11 to stably image the defective items or the like even in a comparatively dark environment in the plant P.

Moreover, the plant P is provided with a computer 13. The computer 13 is provided with an input unit 14, an estimating unit 15, an output unit 16 and a learning unit 17, and the target classification images of the defective items or the like obtained by the imaging unit 11 are input to the input unit 14. The computer 13 is also provided with a non-illustrated processor, and the processor is configured to execute the processing by the estimating unit 15 and the like based on a program stored in a non-illustrated storage device.

The estimating unit 15 is provided with a first estimating unit 15a, a second estimating unit 15b, a third estimating unit 15c, a trained artificial intelligence 18 stored in a non-illustrated storage device, and a determining unit 19. Moreover, the estimating unit 15 is fed with the target classification images obtained by the imaging unit 11, through the input unit 14.

The first estimating unit 15a is configured to estimate the types of the defective items or the like related to the input target classification images by using the target classification images and the artificial intelligence 18.

The second estimating unit 15b is configured to estimate the origin of mixture (the cause of mixture) of the defective items or the like related to the target classification images by using the target classification images and the artificial intelligence 18. More specifically, the second estimating unit 15b is configured to estimate whether the origin is a pre-delivery origin indicating that the defective items or the like related to the target classification images were mixed before the delivery to the plant P or an origin other than that. Here, examples of the pre-delivery origin include a raw material origin indicating that mixture occurred in the production place of the raw material and a distribution process origin indicating that mixture occurred in the distribution process where the raw material was delivered from the production place to the plant P. In the present embodiment, the second estimating unit 15b estimates whether the origin of the defective items or the like related to the target classification images is the raw material origin or an origin other than that.

The third estimating unit 15c is configured to estimate, when the second estimating unit 15b estimates that the origin is an origin other than that, that is, an origin other than the pre-delivery origin (raw material origin), that the origin is a plant origin indicating that the defective items related to the target classification images were mixed in the plant.

The estimation results by the estimating unit 15 (the first estimating unit 15a to the third estimating unit 15c) are output to a display 20 through the output unit 16. In the present embodiment, the estimating unit 15 transmits a predetermined signal to the display 20 through the output unit 16 so that the estimation results are displayed on the display 20.

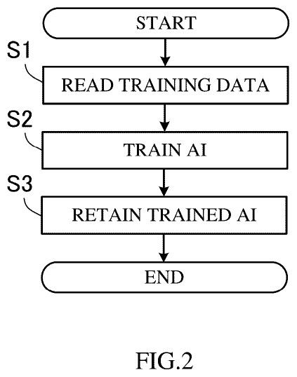

The learning unit 17 is configured to perform machine learning of the artificial intelligence 18. Next, using FIG. 2, the learning of the artificial intelligence 18 by the learning unit 17 will be described. In the present embodiment, the processing by the learning unit 17 is previously executed before the plant P starts operating.

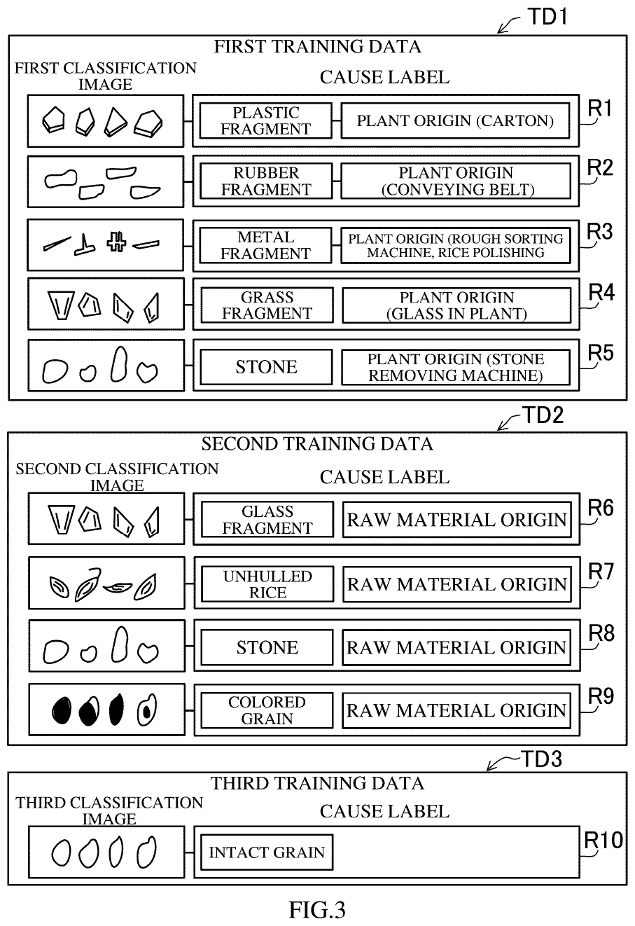

At step S1, previously prepared training data is read. The training data is data where the classification images and cause labels indicating the causes of the mixture are associated with each other. In the present embodiment, as shown in FIG. 3, first training data TD1, second training data TD2 and third training data TD3 are provided.

The first training data TD1 is provided with: data where a first classification image of plastic fragments and a first cause label R1 of the plastic fragments are associated with each other; data where a first classification image of rubber fragments and a second cause label R2 of the rubber fragments are associated with each other; data where a first classification image of metal fragments and a third cause label R3 of the metal fragments are associated with each other; a first classification image of glass fragments and a fourth cause label R4 of the glass fragments; and data where a first classification image of stones and a fifth cause label R5 of the stones are associated with each other. In the first cause label R1 to the fifth cause label R5, the cause of mixture is set to the plant origin. The detailed mixture origin, that is, the cause of mixture of the defective items or the like is set: in the first cause label R1, to a fragment of the carton used in the receiving inspection; in the second cause label R2, to a fragment of the conveying belt installed in the plant P; in the third cause label R3, to a fragment of the rough sorting machine 3 (grain sorting screen) or a fragment of the rice polishing machine 4 (rice polishing screen); in the fourth cause label R4, to a fragment of glass in the plant P; and in the fifth cause label R5, to abnormality of the stone removing machine 5. Thereby, the machine or the like in the plant P that is the cause of mixture of the defective items or the like can be identified by estimating the types of the defective items or the like by using the target classification images. The “first training image” in claims corresponds to the “first classification image” in the present embodiment.

The second training data TD2 is provided with: data where a second classification image of glass fragments and a sixth cause label R6 of the glass fragments are associated with each other; data where a second classification image of unhulled rice and a seventh cause label R7 of the unhulled rice are associated with each other; data where a second classification image of stones and an eighth cause label R8 of the stones are associated with each other; and data where a second classification image of colored grains and a ninth cause label R9 of the colored grains are associated with each other. In the sixth cause label R6 to the ninth cause label R9, the cause of mixture is set to the raw material origin (the production place of the grain raw material). Although not shown, in the present embodiment, the detailed mixture origin, that is, the cause of mixture of the defective items or the like is set: in the sixth cause label R6, to the production place of brown rice (the farm field, the harvester, etc.); in the seventh cause label R7, to abnormality of the huller (used for hulling before the delivery to the plant P); in the eighth cause label R8, to the production place of brown rice (the farm field, the harvester, etc.); and in the ninth cause label R9, to the production place of brown rice (growth conditions such as the farm field, unstable weather and unusual infestation of pests). Thereby, information on the cause of mixture of the defective items or the like can be appropriately fed back to the farmer who produced the brown rice (grain raw material). The “second training image” in claims corresponds to the “second classification image” in the present embodiment.

The third training data TD3 is data where a third classification image of intact grains and a tenth cause label R10 are associated with each other. The “training image” in claims includes the “first classification image”, the “second classification image” and the “third classification image” in the present embodiment.

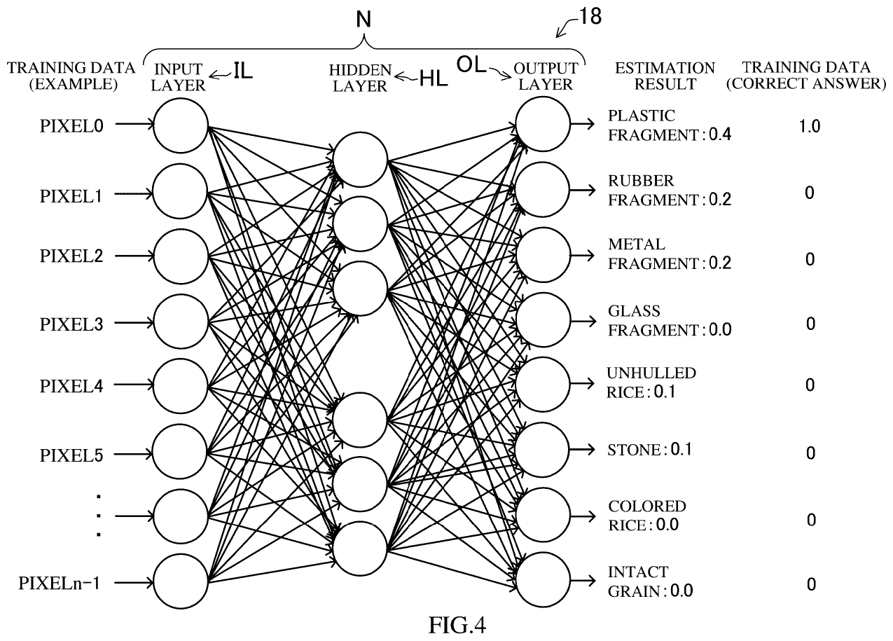

At step S2 of FIG. 2, the training of the artificial intelligence 18 (FIG. 1) is performed using the first training data TDI to the third training data TD3, thereby generating the trained artificial intelligence 18. Here, as shown in FIG. 4, the artificial intelligence 18 is provided with a neural network N. The neural network N includes an input layer IL, a hidden layer HL, an output layer OL and parameters (weighting values, biases), and each layer is provided with neurons. In the present embodiment, the neural network N is a convolutional neural network, and the hidden layer HL is provided with a convolutional layer, a pooling layer and a fully connected layer.

Moreover, at step S2, the pixel values of the classification images (examples) of the first training data TD1 to the third training data TD3 are input to the input layer IL. The neural network N performs estimation at the hidden layer HL based on the classification images input to the input layer IL, and outputs the estimation results to the output layer OL. Then, based on the differences between the output estimation results of the output layer OL and the correct answers (labels) of the first training data TD1 to the third training data TD3, the training processing is performed to optimize the parameters (weighting values, biases) of the neurons of the neural network N so that the differences are reduced.

FIG. 4 shows an example of the training processing of the neural network N (the artificial intelligence 18) using the first classification image of a plastic fragment in the first training data TD1. First, the pixel values of the first classification image of the plastic fragment in the first training data TD1 are input to the input layer IL. Then, at the hidden layer HL, estimation is performed based on the pixel values of the first classification image input to the input layer IL, and the estimation result is output from the output layer OL. In the example shown in FIG. 4, the estimation result of the neural network N is as follows: The possibility of a plastic fragment is 0.4(40%); the possibility of a rubber fragment is 0.2 (20%); the possibility of a metal fragment is 0.2(20%); the possibility of a glass fragment is 0.0(0%); the possibility of unhulled rice is 0.1(10%); the possibility of a stone is 0.1(10%); the possibility of colored rice is 0.0(0%); and the possibility of an intact grain is 0.0(0%).

Then, based on the difference between the estimation result output from the output layer OL and the correct answer (label) of the first training data TD1, training is performed to optimize the weighting values and biases of the neurons of the neural network N so that the difference between the estimation result and the correct answer (label) of the first training data TD1 is reduced. FIG. 4 illustrates an example in which the possibility of a plastic fragment is set to 1.0 and the possibilities of rubber fragments, metal fragments, glass fragments, unhulled rice, stones, colored rice and intact grains are set to 0.0 because the correct answer (label) of the first training data TD1 is a plastic fragment.

Training similar to the above-described one is performed for the other data of the first training data TD1, the second training data TD2 and the third training data TD3. In the present embodiment, the trained artificial intelligence 18 is generated by repetitively performing training until the differences between the estimation results and the correct answers (labels) of the first training data TD1 to the third training data TD3 become not more than a predetermined value.

At step S3, after the trained artificial intelligence 18 generated at step S2 is stored, the process proceeds to END to end the present processing. In the present embodiment, the trained artificial intelligence 18 is stored and retained in a non-illustrated storage device in the estimating unit 15.

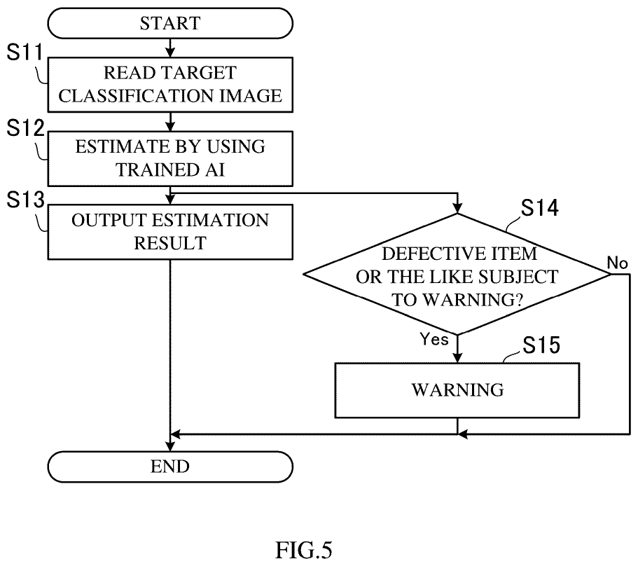

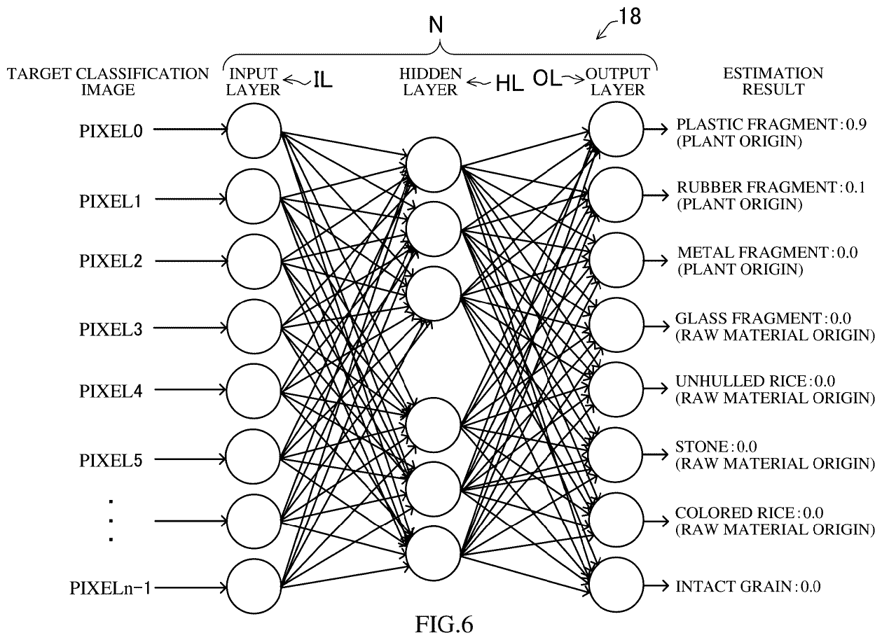

Next, using FIGS. 5 and 6, the processing by the estimating unit 15 (the first estimating unit 15a to the third estimating unit 15c) executed while the plant P is in operation will be described.

At step S11, a target classification image is read. The target classification image is an image of a defective item or the like taken by the imaging unit 11, and is input to the estimating unit 15 from the imaging unit 11 via the input unit 14.

At step S12, estimation is performed based on the input target classification image and the trained artificial intelligence 18, and as shown in FIG. 6, the estimation result is output from the output layer OL. Then, step S13 and step S14 are performed in parallel. In the example shown in FIG. 6, since the possibility of a plastic fragment is 0.9(90%), the possibility of a rubber fragment is 0.1(10%) and the possibilities of a metal fragment, a glass fragment, unhulled rice, a stone, colored rice and an intact grain are 0.0(0%), it is estimated that the type of the defective item or the like of the target classification image is a plastic fragment and the cause of mixture is plant origin (a fragment of the carton). Describing the processing of step S12 in more detail, the first estimating unit 15a estimates the type of the defective item or the like of the target classification image based on the target classification image and the artificial intelligence 18 (in the example shown in FIG. 6, it is estimated to be a “plastic fragment”), the second estimating unit 15b estimates whether the defective item or the like is of raw material origin or not based on the target classification image and the artificial intelligence 18 (in the example shown in FIG. 6, it is estimated to be “not of raw material origin”). The third estimating unit 15c estimates that the defective item or the like is of “plant origin” based on the estimation result of the second estimating unit 15b that the defective item or the like is “not of raw material origin”, that is, is of origin other than raw material origin.

At step S13, after the estimation result of step S12 is output, the process proceeds to END to end the processing. In the present embodiment, by transmitting a signal as to the estimation result from the estimating unit 15 to the display 20 via the output unit 16, the estimation result is displayed on the display 20 that has received the signal.

At step S14, the determining unit 19 determines whether or not the defective item or the like estimated at step S12 is the defective item or the like subject to warning. When the determination is Yes, the process proceeds to step S15, whereas when the determination is No, the process proceeds to END to end the processing. In the present embodiment, the defective items or the like subject to warning are set to plastic fragments, rubber fragments, metal fragments, glass fragments and stones that are of plant origin.

At step S15, since there is a possibility that the line of the plant P is in an abnormal condition, the determining unit 19 warns the operator, and then, the process proceeds to END to end the processing. In the present embodiment, the determining unit 19 transmits a signal to the display 20 via the output unit 16 so that a warning display is provided on the display 20. The warning display prompts the operator to perform an inspection or the like of the carton when the defective item or the like is a plastic fragment, an inspection or the like of the conveying belt when the defective item or the like is a rubber fragment, and an inspection or the like of the rough sorting machine 3 (grain sorting screen) or the rice polishing machine 4 (rice polishing screen) when the defective item or the like is a metal fragment. The operator checks the warning displayed on the display 20 and performs an inspection or the like of the place related to the warning, whereby failure or abnormality of a machine or the like in the plant P can be found at an early stage.

By the above, according to the present embodiment, when a target classification image obtained by imaging a defective item or the like is input to the artificial intelligence 18 of the first estimating unit 15a, the type of the item classified as not meeting the standard is estimated at the first estimating unit 15a. Here, since the artificial intelligence 18 is trained using the first classification image and the second classification image, the type of the defective item or the like can be estimated in more detail compared with when the values of R, G and B are compared with a predetermined discriminant as in Patent Literature 1. This enables guarantee of the quality of the items to be classified (for example, brown rice) in the distribution process.

Moreover, when a raw material (for example, brown rice) is processed into a product (for example, polished rice) and shipped at the plant P, the raw material is inspected at the optical sorting machine 7 and classified into non-defective items or the like and defective items or the like. Then, target classification images obtained by imaging the defective items or the like are input to the artificial intelligence 18 of the first estimating unit 15a to enable estimation of the types of the defective items or the like at the first estimating unit 15a. By doing this, the types of the defective items or the like can be estimated in detail compared with the above-described case of Patent Literature 1, so that the quality in the processing process in the plant P can be guaranteed.

Moreover, whether the mixture origin of the defective items or the like is the raw material origin indicating that mixture occurred in the production place of the grain raw material or an origin other than that can be estimated by the second estimating unit 15b. By this, whether or not the defective items or the like were mixed in the production place of the grain raw material before the delivery to the plant P can be estimated even after the delivery of the grain raw material to the plant P.

Moreover, the defective items or the like estimated to be of other than raw material origin at the second estimating unit 15b can be estimated to be of plant origin at the third estimating unit 15c.

Moreover, the third estimating unit 15c is capable of estimating the mixture origins of defective items or the like by using the artificial intelligence 18 trained using the training data where the types of the defective items or the like and the mixture origins are associated with each other.

The third estimating unit 15c is capable of estimating the mixture origin of defective items or the like by using the artificial intelligence 18 trained using the first training data TD1 and the second training data TD2.

When the defective items or the like are estimated to be subject to warning, the operator is warned of this. This makes it possible to prompt the operator to, for example, inspect or stop a machine or the like related to the defective items or the like.

While the present embodiment has been described using an example in which the items to be classified are brown rice and polished rice, the raw materials may be other than brown rice and polished rice (for example, wheat, barley, soybeans, corn, seafood, vegetables, fruit, coal, iron ore, machine components, electrical components, electronic components, semiconductor materials, or resin materials, or the like). Moreover, the traceability system 1 may be adopted to plants that perform processing of raw materials other than brown rice and polished rice, food plants that produce snack foods or frozen foods, manufacturing plants that manufacture mechanical products, electrical products, semiconductor products, plastic products or the like or environments other than plants. Examples of application to environments other than plants include the production place of the raw material, the distribution channel from the production place to the plant and the distribution channel of the product shipped from the plant.

While an example using the optical sorting machine 7 as the separating unit has been described in the present embodiment, a machine or the like other than the optical sorting machine 7 may be used as long as it is capable of inspecting the items to be classified and separating them into items meeting the standard and items not meeting the standard.

While the imaging unit 11 images only the defective items or the like separated at the optical sorting machine 7 in the present embodiment, a structure may be adopted in which the defective items or the like and the non-defective items or the like are imaged and only the images (target classification images) of the defective items or the like are transmitted to the input unit 14, or a structure may be adopted in which images of the defective items or the like and the non-defective items or the like are transmitted to the input unit 14, only the target classification images are extracted from the images at the computer 13 and the extracted target classification images are used to perform estimation at the estimating unit 15. While the imaging unit 11 is provided for inspecting the items to be classified, a structure may be adopted in which data other than image data such as waveform data or numerical data is handled.

While the learning unit 17 is provided in the computer 13 in the present embodiment, it may be provided in a computer other than the computer 13. In this case, after the artificial intelligence 18 performs learning at the other computer, the artificial intelligence 18 may be stored in a non-illustrated storage device of the estimating unit 15 of the computer 13.

While the estimating unit 15 performs estimation by using the trained artificial intelligence 18 in the present embodiment, the artificial intelligence 18 may further perform learning at times such as when the plant P is not in operation.

While the artificial intelligence 18 is provided with a convolutional neural network in the present embodiment, it may be provided with a different neural network such as a fully convolutional network. Moreover, design of experiments, deep learning, fuzzy logic, multivariate analysis (for example, Mahalanobis' distance, multiple regression analysis), sparse modeling, a support vector machine or the like may be used for the artificial intelligence 18.

While the cause of mixture (mixture origin) of the defective items or the like is estimated at step S12 in the present embodiment, when the cause of mixture is unknown, that is, when it cannot be estimated, this may be output to the display 20 or may be included in a technical report TR, or the operator may be warned of this.

While an example in which the second estimating unit 15b estimates whether the mixture origin of the defective item or the like related to the target classification image is the raw material origin indicating that mixture occurred in the production place of the raw material or an origin other than that is described in the present embodiment, the second estimating unit 15b may estimate whether the defective item or the like related to the target classification image is of pre-delivery origin indicating that mixture occurred before the delivery to the plant P or of origin other than that. By doing this, whether the mixture origin of the defective item or the like is pre-delivery to the plant origin or an origin other than that can be estimated by the second estimating unit 15b. By this, whether the defective item or the like was mixed before the delivery to the plant P or not can be estimated even after the delivery of the raw materials to the plant P.

Moreover, as a modification, the second estimating unit 15b may estimate whether the mixture origin of the defective item or the like related to the target classification image is the raw material origin indicating that mixture occurred in the production place of the raw material, the raw material distribution origin indicating that mixture occurred in the distribution process to the delivery to the plant P or an origin other than that. By doing this, when the defective item or the like is of pre-delivery to the plant P origin, it can be estimated whether the mixture origin is the raw material origin indicating that mixture occurred in the production place of the raw material or the raw material distribution origin indicating that mixture occurred in the distribution process where the raw material is delivered from the production place to the plant P. Further, as a modification, the second estimating unit 15b may estimate whether the mixture origin of the defective item or the like related to the target classification image is the raw material distribution origin indicating that mixture occurred in the distribution process from the production place of the raw material to the delivery to the plant P or an origin other than that.

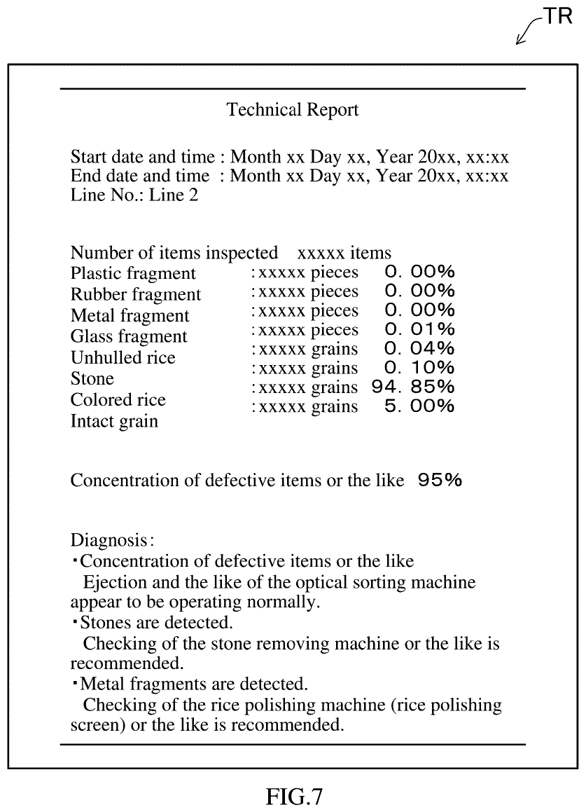

While the estimation results by the estimating unit 15 are output to the display 20 at step S13 in the present embodiment, a technical report TR on a summary of the estimation results may be created as shown in FIG. 7, and the technical report TR may be shown on the display 20. Alternatively, a piece of paper containing the technical report TR may be output from a non-illustrated printer. Further, the quality of the plant P may be appealed to customers by showing the technical report TR containing numerical values of the defective items or the like of the plant origin as shown in FIG. 7.

While not performed in the present embodiment, the following may be performed: The estimation results by the estimating unit 15 are stored as history information in a non-illustrated storage device so that, when a change occurs in the estimation results by the estimating unit 15, abnormality or the like of a machine or the like in the plant P can be found at an early stage by providing a display on the display 20 (technical report TR) or by providing the operator with a warning, or when an inquiry concerning mixture of a defective item or the like is received from a customer, the cause of the mixture of the defective item or the like about which the inquiry is received is grasped with reference to a past technical report TR or the history information of the estimation results. Further, images of the items to be classified may be displayed on the display 20 (technical report TR).

While the defective items or the like subject to warning at step S14 are set to plastic fragments, rubber fragments, metal fragments, glass fragments and stones of the plant origin in the present embodiment, when there are an abnormally large number of intact grains (when the number of intact grains is not less than a predetermined number), the intact grains may be set as defective items or the like. Because an abnormally large number of intact grains can result from abnormal operation of the optical sorting machine 7, warning may be provided at step S15 to prompt the operator to perform an inspection or the like of the optical sorting machine 7. By doing this, an inspection or the like of the optical sorting machine 7 is performed by the operator visually recognizing the warning (warning display), whereby abnormal operation of the optical sorting machine 7 can be found at an early stage.

While stones are not set as the defective items or the like subject to warning at step S14 in the present embodiment, because there is a possibility that the stone removing machine 5 is operating abnormally when the defective items or the like estimated at step S12 are stones, warning may be provided at step S15 to thereby prompt the operator to perform an inspection or the like of the stone removing machine 5. By doing this, an inspection or the like of the stone removing machine 5 is performed by the operator having visually recognized the warning (warning display), whereby abnormal operation of the stone removing machine 5 can be found at an early stage.

Moreover, in the present embodiment, when it is determined that the defective item or the like is a defective item or the like subject to warning at step S14, the determining unit 19 may instruct the operator to provide feedback to the preceding process (stopping of a machine in the plant P related to the defective item or the like). By doing this, when the defective item or the like is estimated to be subject to warning, the operator can be notified of the instruction to provide feedback to the preceding process. Thereby, for example, it is possible to prompt the operator to stop a machine or the like related to the defective item or the like subject to warning.

While the first training data TD1 consists of data of plastic fragments, rubber fragments, metal fragments, glass fragments and stones in the present embodiment, it may consist of data of at least one of plastic fragments, rubber fragments and metal fragments.

While the second training data TD2 consists of data of glass fragments, unhulled rice, stones and colored grains in the present embodiment, it may consist of data of at least one of glass fragments, unhulled rice, stones and colored grains.

While the training data is provided with the third training data TD3 in the present embodiment, it is not necessarily provided with the third training data TD3.

While the artificial intelligence 18 performs learning by supervised learning using training data in the present embodiment, it may perform learning by semi-supervised learning that combines supervised learning using training data and unsupervised learning.

While the estimating unit 15 is provided with the determining unit 19 in the present embodiment, the determining unit 19 may be provided separately from the estimating unit 15.

While the determining unit 19 causes the display 20 to provide warning display at step S15 in the present embodiment, a warning sound may be output instead of the warning display or in addition to the warning display.

### INDUSTRIAL APPLICABILITY

The present invention is suitable as, for example, a transability system provided in the distribution process of items to be classified such as grain raw materials.

### DESCRIPTION OF REFERENCE CHARACTERS

1 Traceability system
7 Optical sorting machine (separating unit)
11 Imaging unit (image obtaining unit)
15a First estimating unit
15b Second estimating unit
15c Third estimating unit
18 Artificial intelligence
19 Determining unit
P Plant
TD1 First training data
TD2 Second training data

1. A traceability system comprising:
a separating unit for, when a raw material delivered to a plant is processed into a product and shipped, inspecting the product and separating the product into an item meeting a standard and an item not meeting the standard;
an image obtaining unit for imaging the item classified as not meeting the standard to obtain a target image;
a first estimating unit for inputting the target image to an artificial intelligence trained using a training image to estimate a type of the item classified as not meeting the standard;
a second estimating unit for estimating, by using the artificial intelligence, whether the item classified as not meeting the standard is of pre-delivery origin indicating that mixture occurred before the delivery to the plant or of origin other than that;
a third estimating unit for, when the item classified as not meeting the standard is estimated to be of the origin other than that at the second estimating unit, estimating that the item classified as not meeting the standard is of plant origin indicating that mixture occurred in the plant; and
a determining unit for, when the item classified as not meeting the standard is estimated to be of the plant origin at the third estimating unit, warning an operator or instructing the operator to provide feedback to a preceding process.

2. The traceability system according to claim 1,
wherein the pre-delivery origin is at least one of a raw material origin indicating that mixture occurred in a production place of the raw material and a raw material distribution origin indicating that mixture occurred in a distribution process where the raw material is delivered from the production place to the plant, and
the artificial intelligence is trained using first training data where a first training image of the item classified as not meeting the standard and a cause label of the plant origin are associated with each other and second training data where a second training image of the item classified as not meeting the standard and a cause label of the raw material origin are associated with each other.
